(19) United States
(12) Patent Application Publication
(10) Pub. No.: US 2016/0303896 A1
(43) Pub. Date: Oct. 20, 2016

(54) Novel Wheel and Methods of Production

(71) Applicant: Ilan Ben Meir, Ra'anana (IL)

(72) Inventor: Ilan Ben Meir, Ra'anana (IL)

(21) Appl. No.: 15/038,682

(22) PCT Filed: Nov. 23, 2014
(86) PCT No.: PCT/IL2014/051016

§ 371 Date: May 23, 2016

Related U.S. Application Data
(60) Provisional application No. 61/908,131, filed on Nov. 24, 2013.

(51) Int. Cl. B60B 9/00; B60B 3/08; C08J 5/00; B29C 47/00; B29C 47/06; B60B 5/02; B29C 49/22

(52) U.S. Cl. CPC B60B 9/00; B60B 5/02; B60B 3/085; B29C 49/22; B29C 47/0026; B29C 47/065; C08J 5/00; B60B 2200/43; B60B 2200/45; B60B 2200/47; B60B 2310/204; B60B 2310/214; B60B 2360/324; B60B 2360/322; B60B 2360/32; B60B 2900/112; B60B 2900/113; B60B 2900/311; B60B 2900/313; B60B 2900/3312; B60B 2900/572; B60B 2900/321; B29L 2023/18

(57) ABSTRACT

The invention is directed to novel wheels useful for various products including strollers, vehicles for children, carts, luggage trollies and bags, tricycles, bicycles and toys, and methods of production. The novel wheel comprising a flexible annular segment manufactured by a blow molding process, said segment having at least one layer made of a thermoplastic elastomer; and a wheel hub configured to support the flexible annular segment from each of its sides and to create a cylinder for insertion of an axle therethrough so as to allow connection of the wheel to other components of a product. In one alternative implementation of the invention, the flexible annular segment manufactured is manufactured by extrusion molding process. The invention is further directed to methods for manufacturing the novel wheel.

### FIELD OF THE INVENTION

The present invention is directed to novel wheels useful for various products including strollers, vehicles for children, carts, luggage trollies and bags, tricycles, bicycles and toys, and methods of production.

### BACKGROUND

Blow molding is a manufacturing process by which hollow plastic parts are formed. In general, there are three main types of blow molding: extrusion blow molding, injection blow molding, and injection stretch blow molding. The blow molding process begins with melting down thermoplastic materials and forming the melted materials into a parison or a pre-form. The parison is a tube-like piece of plastic with a hole in one end through which compressed air can pass. The parison is then clamped into a mold and air is blown into it. The air pressure then pushes the plastic out to match the mold surface. Once the plastic has been cooled and hardened, the mold opens up and the part is ejected.

Extrusion moulding is a manufacturing process usually used to make pipes, rods, and tubes. The molten phase which is forced through a die, results in a long ‘tube like’ shape. The shape of the die determines the shape of the tube. The extrusion is then cooled and forms a solid shape. The long continuous tube may be cut at equal intervals according to the desired use. Extrusion process for the production of corrugated tubes, pipes, and rods is well known in the art. The most common use of such corrugated tubes is for the delivery of liquids, wherein the corrugated tube serves as a means for transferring said liquids.

In the field of baby strollers, bicycles, tricycles, scooters and other vehicles for kids and adults, cart, trolley bags and luggage, and the like, the wheels are one of the most expensive components that increase the price of such products significantly. Many wheels available in the market are made of foamed Ethylene vinyl acetate (EVA) that is a polymer that approaches elastomeric materials in softness and flexibility. Recently, the usage of EVA for such purposes has become problematic due to regulation problems. Additionally, these wheels suffer from fast abrasion, and low capacity.

A substitute material for the production of such wheels is foamed Polyurethane. This material by itself is an expensive material that raises the product cost.

Additionally, the wheels that are produced by the blow process that are available today are generally formed from plastic materials that give the wheel a cheap look, make noise while in usage, and suffer from fast abrasion.

Thus, there is a real need in the market for wheels with a good quality that are suitable for such products, that are safe to use, that their production cost is minimal, that they are stable and have a high capacity, that they have a high quality look and good functioning, and finally, that they exhibit slow abrasion and are wear-resistant. The present invention is directed to a novel wheel that is cheap and fast to produce, that is stable and of high quality, and that further comprises an inherent shock absorber as will be described in details herein forth.

### SUMMARY OF THE INVENTION

The subject matter disclosed herein is directed in one main aspect to a novel wheel comprising: a flexible annular segment manufactured by a standard blow molding process, the segment having at least one layer made of a thermoplastic elastomer; and a wheel hub configured to support the flexible annular segment from each of its sides and to create a cylinder for insertion of an axle through it so as to allow connection of the wheel to other components of a product.

In one another aspect, the subject matter disclosed herein is directed to a method for manufacturing a wheel, said method comprising the following steps:

a. Creating a blow molded corrugated shape tank appearing as part of a corrugated tube with at least one layer of a thermoplastic elastomer via a blow molding process;

b. Slicing annular segments of said blow molded tank; and

c. Assembling said sliced annular segments on a wheel hub for supporting the flexible annular segment from each of its sides and creating a cylinder for insertion of an axle through it to allow connection of the wheel to other components of a product.

In one further aspect, the subject matter of the invention is directed to a wheel comprising: a flexible annular segment manufactured by an extrusion molding process, the segment having at least one layer made of a thermoplastic elastomer; and a wheel hub configured to support the flexible annular segment from each of its sides and to create a cylinder for insertion of an axle through it so as to allow connection of the wheel to other components of a product.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings.

The figures (FIGS.) are listed below.

FIGS. 1A-1B are schematic front view and isometric view illustrations of a novel wheel in accordance with the present invention.

FIG. 2 is a schematic cross section view of the wheel of FIG. 1 wherein the wheel is lying in horizontal position.

FIGS. 3A-3B are exploded view illustration and cross section view of the components shown in the exploded view respectively, of the novel wheel of FIG. 1.

FIG. 4 is a schematic illustration of one optional example for manufacturing flexible segments of a corrugated tube, to be assembled with a wheel hub and optionally, a cover to create a wheel.

FIG. 5 is a schematic isometric view of a corrugated tube with a large number of segments, wherein each segment comprises multiple layers made by an extrusion process and is operable to be used as a flexible annular segment for manufacturing a wheel.

FIG. 6 is a schematic illustration of one other example for producing flexible annular segments by a blow molding process to be assembled on a wheel hub.

FIG. 7A-7B are schematic isometric view and exploded view illustrations of a novel wheel comprising a flexible annual segment manufactured by a blow molding process in accordance with the present invention.

FIG. 8A-8C are schematic illustrations of a blow molded corrugated shape tank appearing as part of a corrugated tube wherein, FIG. 8A illustrates a front view of the tank after it is cooled and removed from the mold, FIG. 8B is a cross section view of the blow molded tank of FIG. 8A along line B-B showing the inner structure of the blow molded tank, and FIG. 8C is a close-up view of area “Z” of part of an annual flexible segment shown in the cross section of FIG. 8B.

### DESCRIPTION OF VARIATIONS OF THE INVENTION

In the following description, various aspects of a novel wheel and methods of production of the wheel are described. For the purpose of explanation, specific configurations and details are set forth in order to provide a thorough understanding of the invention.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

Terms for indicating relative direction or location, such as “right” and “left”, “up” and “down”, “top” and “bottom”, “horizontal” and “vertical”, “higher” and “lower”, and the like, may also be used, without limitation.

In accordance with one main aspect of the invention, a blow molding process is used to manufacture a flexible corrugated shape tank appearing as part of a corrugated tube, with a pre-defined number of segments according to the dimensions of a mold in use, wherein each segment created by this process is cut from the tank, assembled on a wheel hub, and optionally, closed by a cover so as to create a functional wheel.

In accordance with another aspect of the present invention, a flexible corrugated tube having multiple layers is created via an extrusion process, wherein each segment of this corrugated tube is cut from the tube, assembled on a wheel hub, and optionally, closed by an additional cover so as to create a functional wheel.

As will be described in details below, both processes allow mass production of the novel wheel, wherein in the blow molding process a closed corrugated shaped tank is produced that is being cut into segments to be assembled on a wheel hub, while in the extrusion process an open corrugated tube is initially manufactured and being sliced into the segments for assembling with a wheel hub.

Thus, the present invention is one aspect is aimed to provide a wheel comprising:

(a) a flexible annular segment manufactured by a blow molding process, said segment having at least one layer made of a thermoplastic elastomer; and

(b) a wheel hub configured to support the flexible annular segment from each of its sides and to create a cylinder for insertion of an axle through it so as to allow connection of the wheel to other components of a product.

The thermoplastic elastomer may be selected from the group consisting of thermoplastic rubber, EVA (Ethylene Vinyl Acetate), PVC rubber, Styrenic block copolymers (TPE-s),Polyolefin blends (TPE-o), Elastomeric alloys (TPE-v or TPV), Thermoplastic polyurethanes (TPU), Thermoplastic copolyester, and Thermoplastic polyamides. The above list of optional materials is provided for explanations and should not be construed as a limiting the scope of the invention.

In a preferred embodiment, the flexible segment comprises at least two layers, an outer layer made of a thermoplastic elastomer, and an inner layer made of at least one of the following materials: polypropylene, polyethylene, PVC (Polyvinyl chloride), ABS (Acrylonitrile butadiene styrene), and nylon. The outer layer made of a thermoplastic elastomer is configured to serve as a shock absorber and/or as a wear resistant layer. The flexible segment may comprise additional layers as described below.

In some examples of the invention, the flexible segment is a slice of a corrugated shape tank, manufactured in a blow molding process. Alternatively, the flexible annular segment may be manufactured by an extrusion process as part of a corrugated open tube.

As mentioned above, the novel wheel manufactured by either one of blow molding process or an extrusion process may be used for various products such as, but not limited to, strollers, children vehicles, carts, trolley bags, luggage trollies, and other vehicles for adults such as scooters, tricycles and bicycles.

In accordance with the present invention, the cylinder configured to allow insertion of an axle therethrough, functionally allows the connection of the wheel to an additional wheel.

The present invention is further aimed to provide a method for manufacturing a wheel, said method comprising the following steps:

a. Creating a blow molded corrugated shape tank with at least one layer of a thermoplastic elastomer via a blow molding process;

b. Slicing annular segments of said blow molded tank;

c. Assembling said sliced annular segments on a wheel hub for supporting the flexible annular segment from each of its sides and creating a cylinder for insertion of an axle through it to allow connection of the wheel to other components of a product.

The blow molded tank preferably comprises a plurality of flexible segments wherein each segment is structurally separated from adjacent segments. The thermoplastic elastomer used in this method is preferably selected from the group consisting of thermoplastic rubber, EVA (Ethylene Venyl Acetate), PVC rubber, Styrenic block copolymers (TPE-s), Polyolefin blends (TPE-o), Elastomeric alloys (TPE-v or TPV), Thermoplastic polyurethanes (TPU), Thermoplastic copolyester, and Thermoplastic polyamides. However, other materials available in the market for such use may also be employed.

In some implementations of the invention, the segments are flexible segments comprising at least two layers, an outer layer made of a thermoplastic elastomer and an inner layer made of at least one of the following materials: polypropylene, polyethylene, PVC (Polyvinyl chloride), ABS (Acrylonitrile butadiene styrene), and nylon. The outer layer made of thermoplastic elastomer is preferable configured to serve as a shock absorber and/or as a wear resistant layer. In further embodiments, the flexible segments may be composed of additional layers according to the budget and needs.

The method described above may be used for manufacturing wheels for various products as described in details above with reference to products that are suitable for the wheels of the invention.

The cylinder configured to allow insertion of an axle therethrough, for connecting the wheel to other components of a product, also allows connection of the wheel to an additional wheel.

In some embodiments of the invention, the method for manufacturing a wheel according to the above may be executed by an extrusion molding process, wherein instead of a closed tank, a corrugated tube is created and then sliced into annular segments.

The present invention in a further aspect is directed to a wheel comprising a flexible annular segment manufactured by an extrusion molding process, said segment having at least one layer made of a thermoplastic elastomer; and a wheel hub configured to support the flexible annular segment from each of its sides and to create a cylinder for insertion of an axle through it so as to allow connection of the wheel to other components of a product. The said thermoplastic elastomer in such embodiment may be selected from the group consisting of thermoplastic rubber, EVA (Ethylene Venil Acetate), PVC rubber, Styrenic block copolymers (TPE-s), Polyolefin blends (TPE-o), Elastomeric alloys (TPE-v or TPV), Thermoplastic polyurethanes (TPU), Thermoplastic copolyester, and Thermoplastic polyamides. However, a person skilled in the art would agree that other thermoplatic materials may also be used and the above list should not be construed as limiting the scope of the invention.

In a specific embodiment of the invention, the flexible segment comprises at least two layers, an outer layer made of a thermoplastic elastomer and an inner layer made of at least one of the following materials: polypropylene, polyethylene, PVC (Polyvinyl chloride), ABS (Acrylonitrile butadiene styrene), and nylon.

The outer layer made of thermoplastic elastomer may serve as a shock absorber and/or a wear resistant layer. In a similar manner to the segment originated from the blow molding process above, the flexible segment produced by an extrusion process is a slice of a corrugated tube manufactured in an extrusion molding process.

The wheel may be used for the same type of product as mentioned above, wherein, the cylinder configured to allow insertion of an axle therethrough, also allows connection of the wheel to additional wheel/s.

In a specific example, the wheel manufactured by an extrusion process as described above may further comprise a third layer positioned in parallel to the two other layers in a manner such that said third layer creates, together with the two other layers, a closed compartment, providing the wheel with inherent shock absorber capabilities.

The invention will be further explained and demonstrated by the following descriptions of the figures.

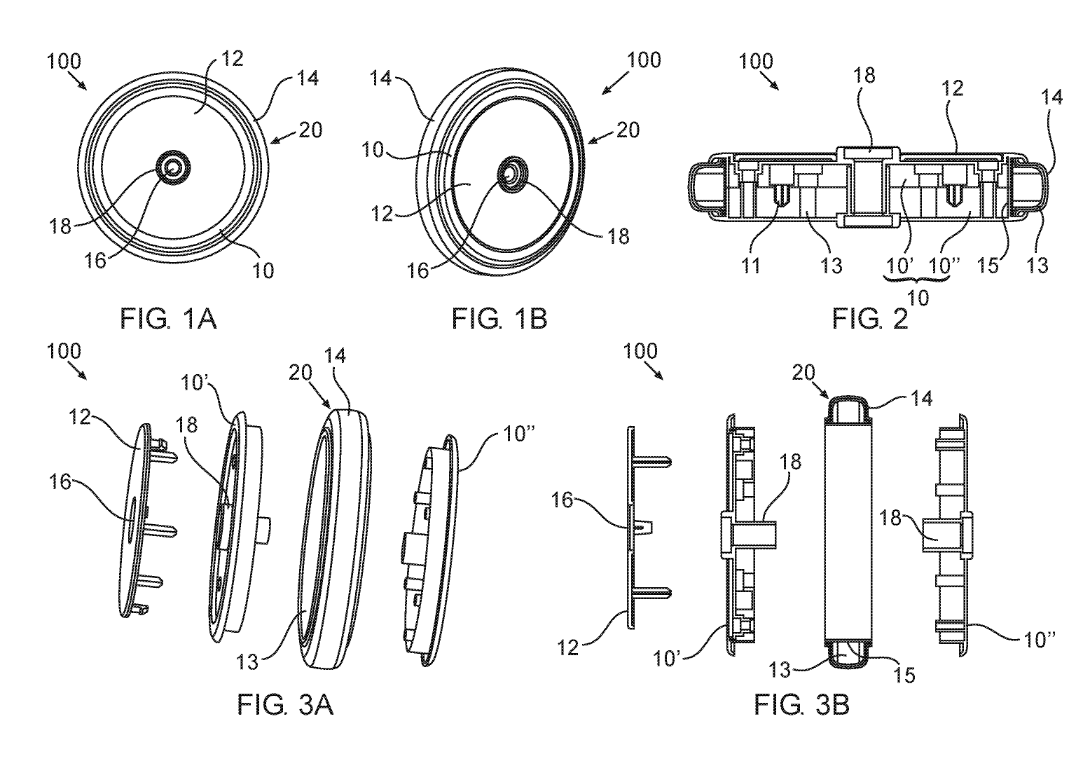

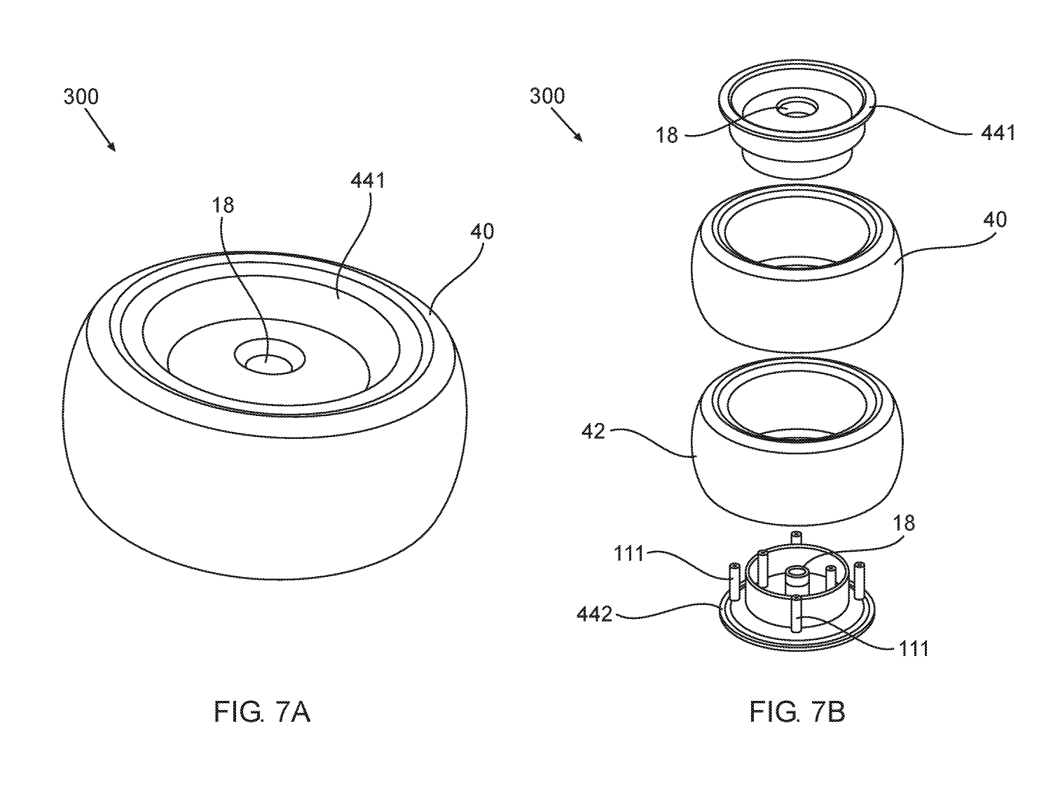

FIGS. 1A-1B provides a front and side views (respectively) of a novel wheel 100 in accordance with examples of the inventions. In these views of wheel 100 the outer layer 14 of a flexible annular segment 20 is shown. Flexible segment 20 is manufactured as part of a corrugated tube by an extrusion process that is sliced (cut) into annular segments 20. Outer layer 14 is preferably made of a thermoplastic elastomer, such as, but not limited to, thermoplastic rubber or other polymers. Segment 20 is assembled with a wheel hub 10, and the assembly may further be connected on the external side or on both sides of the wheel to a wheel cover 12 that is made for example from an injected plastic. In some other implementations of the invention as shown with reference to FIG. 7, the wheel hub is designed in a manner that eliminates the need for the additional cover 12. In the example illustrated in these FIGS., wheel cover 12 comprises a hole 16 suitable in dimensions and position to cylinder 18 created by the wheel hub 10. Cylinder 18 is configured and operable to allow insertion of an axle through it in order to connect the wheel to other components of the product including to additional wheel/s.

FIG. 2 is a schematic cross section view of wheel 100 illustrated in FIG. 1, wherein wheel 100 is lying in a horizontal position. In this view, the different layers that compose flexible segment 20 are shown. Generally, flexible segment 20 comprises at least one layer. In the specific example illustrated in this figure, flexible segment 20, which is a slice of an extruded corrugated tube manufactured by an extrusion process, is composed of three layers: an outer layer 14 adhered to a second layer 13 and an inner layer 15. Outer layer 14 is preferably made of an extruded thermoplastic elastomer (TPE) such as but not limited to, thermoplastic rubber, EVA (Ethylene Venil Acetate), PVC rubber, Styrenic block copolymers (TPE-s), Polyolefin blends (TPE-o), Elastomeric alloys (TPE-v or TPV), Thermoplastic polyurethanes (TPU), Thermoplastic copolyester, and Thermoplastic polyamides. The outer layer is configured to provide the wheel with a desired friction coefficient with respect to the ground, so as to avoid sliding of the vehicle or any other product using the wheel. Layer 13 that is adhered to layer 14 is preferably made of an extruded polypropylene (PP), and configured to carry the load applied on the product. For example, when the product is a vehicle, the inner layer is configured to carry the load of both the vehicle itself and the user riding the vehicle (and in the case of a baby stroller, to carry the stroller and the weight of the baby carried in it). Other suitable materials for layer 13 include, without limitation, polyethylene, PVC (Polyvinyl chloride), ABS (Acrylonitrile butadiene styrene), and nylon. As shown in the figure, layers 13 and 14 are constructed in a shape of a wave pipe, however, it should be clear to a person skilled in the art that any other repeated curve may be applied. This structure eliminates the need for an additional inner lining, as this unique structure of wheel 100 serves as a pseudo lining.

In a specific example, a third layer 15 may be a linear layer positioned in parallel to the two other layers in a manner such that the third layer closes the tips of the “wave” (or any other shape) created by the two other layers and thereby creates, together with the other layers, a closed compartment. This unique structure of such layer provides wheel 100 with inherent shock absorbing characteristics due to the fact that submergence in a close compartment provides an effect of shock absorbance. Layer 15 is preferably composed of an extruded polypropylene (PP), and configured and operable to provide the two other layers 13 and 14 additional support in order to avoid their collapse, and further to allow injection of additional shock absorbing materials in cases where additional material is required.

As mentioned above, flexible segment 20 may comprise at least one layer. In the specific example illustrated herein it comprises two outer layers 13 and 14, whereas the additional layer 15 is only an option and it is somewhat dependent on the manufacturing method that is used for the production of flexible annular segment 20 (will be described in details with reference to FIG. 6 below) and the requirements of the entire product that will use the wheels. Also, additional adhered layer such as layer 13 may be added instead of the linear layer 15 described above.

Also shown in FIG. 2 are: wheel hub 10, wheel cover 12, screws 11, structural connections 13, and cylinder 18. Wheel hub 10 comprises two complementary parts 10′ and 10″ connected to each other by screws 11 and optionally by structural connectors 13. In one alternative, at the center of each part of the wheel hub there is a hole (not shown in this view) configured to allow the insertion of an external cylinder 18 in a transverse direction relative to the wheel hub parts. Alternatively, cylinder 18 may be an integral part of the wheel hub as illustrated in FIGS. 3A and 3B. The wheel hub 10 is a standard component and it is used in the present invention as a platform on which the flexible annular segment 20 is assembled onto. When used, wheel cover 12 is preferably but not necessarily made of a plastic material and serves for a static closing of the wheel when needed or desired. Cover 12 may further be used for commercial purposes so as to present the brand name of the manufacturer on its surface. In some other examples of the invention, the wheel hub is designed in a manner that eliminates the need for an additional cover. Cylinder 18 is configured and operable to allow insertion of an axle through it in order to connect the wheel to the other components of the product including additional wheel/s.

FIGS. 3A and 3B are schematic exploded view illustration and a cross section of the exploded view components respectively, of wheel 100 illustrated in FIG. 1. These figures demonstrate the structural components of the wheel and the order in which they are assembled together. Shown in these figures from left to right are: wheel cover 12 with hole 16 configured to allow insertion of an axle therethrough; one part of wheel hub 10′ having as an integral part thereof one half of cylinder 18; flexible annular segment 20 comprising an outer layer 14 (extruded TPE (e.g. rubber)), internal layer 13 (e.g. extruded PP (polypropylene)), and optionally, internal layer 15 (e.g. extruded PP (polypropylene)); and second part of wheel hub 10″ comprising in its center as an inherent component the second part of cylinder 18. In the exploded cross section view (FIG. 3B), the wave pipe shape of layers 13 and 14 is well shown. Additionally, in accordance with the present invention, the two layers 13 and 14 may be adhered to each other and appear as one complex layer. Alternatively, they may be separated from each other. It should be clear that flexible segment 20 may comprise additional layers and the layers illustrated in this figure are only an example and should not be construed as limiting the scope of the invention in any form.

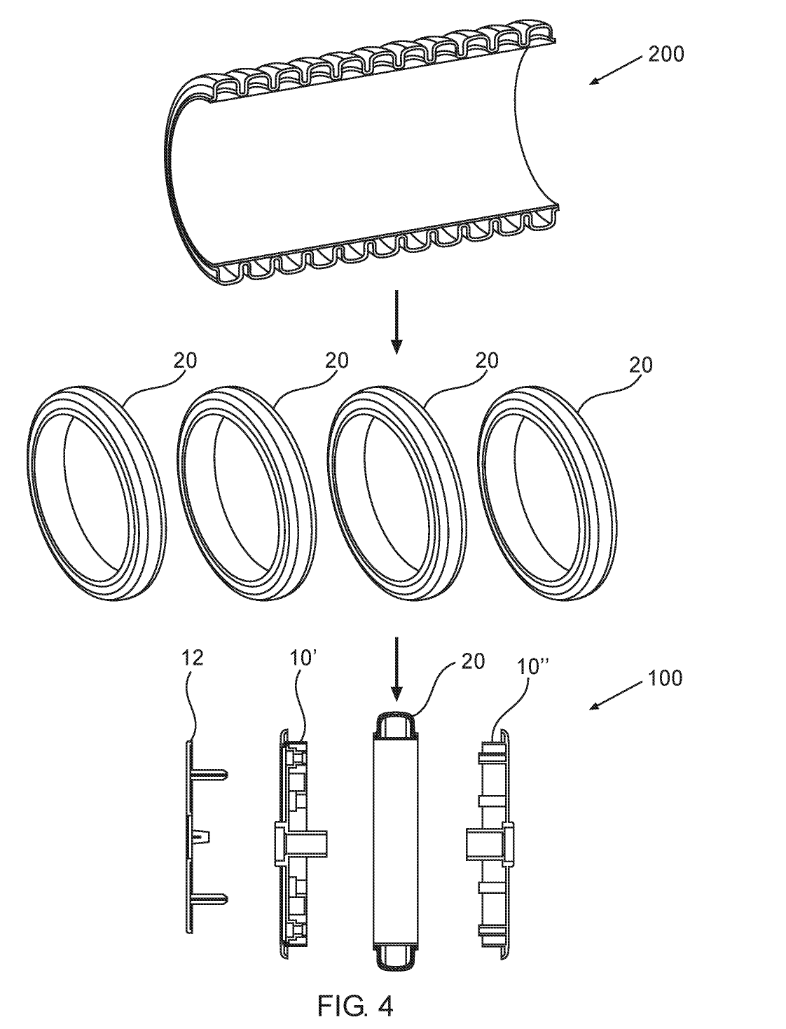

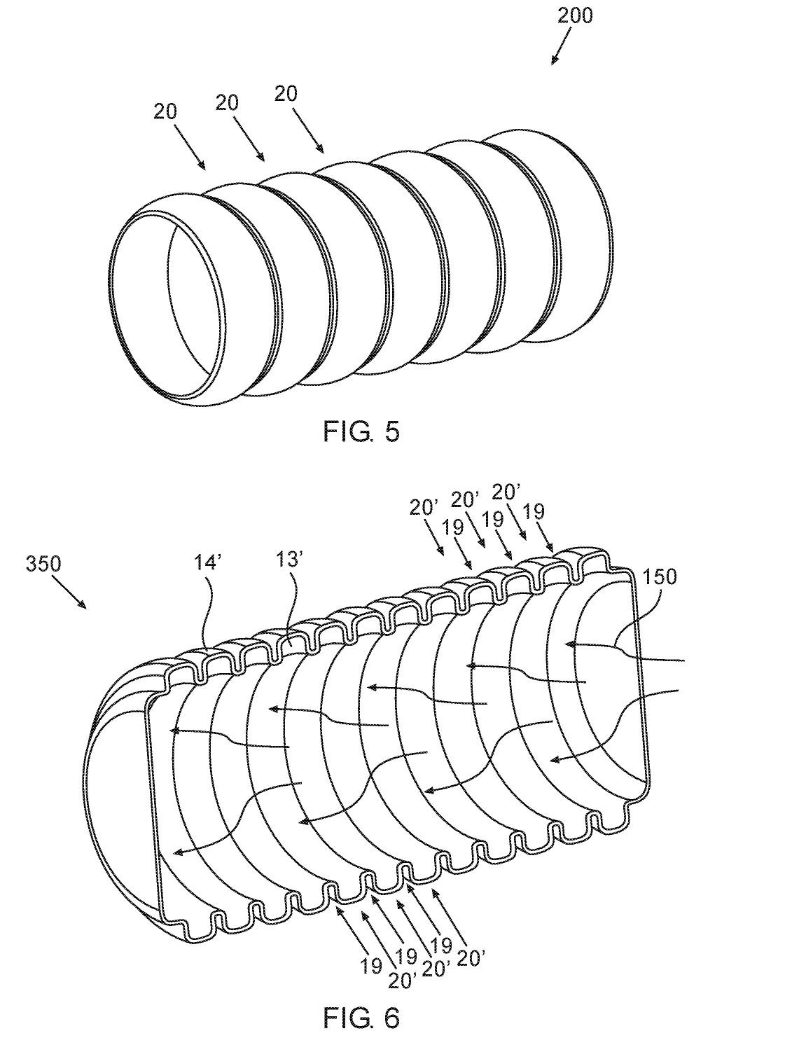

FIG. 4 is a schematic illustration of one optional example for manufacturing a flexible corrugated tube in an extrusion process and slicing it into segments 20 for use as a major component of wheels for strollers, children vehicles, carts, trolley bags and luggage trollies, bicycles and tricycles for adults and scooters. The present invention introduces a novel use for materials and manufacturing processes know in the art for fast and non-expensive mass production of wheels suitable for use in products of the type mentioned above.

In the example illustrated in this figure, a corrugated continuous tube with multiple layers 200 made by extrusion process is first manufactured (a cut of the tube illustrating the layers is shown), and segments 20 of the tube are then cut in a separation process. The cut segments are then assembled with wheel hub 10 comprising two parts 10′ and 10″ and optionally, with a wheel cover 12 (as described in details with reference to FIG. 3 above) to obtain wheel 100. Wheel hub 10 may be a standard off-the-shelf product or self-made, for example, by injection process.

The novel manufacturing method for wheels provided herein is fast and cheap relative to methods for producing the same that are currently known in the art, and it further makes use of materials that are not usually used to produce wheels due to their high cost. Nevertheless, the product of this process is quality, and the shape of the segments produced by this process is advantageous compared to commonly used wheels as it comprises an inherent shock absorber thanks to its structure and the materials that are used, and further avoids the need to use an inner lining. Furthermore, the capabilities to carry loads are similar to the capabilities of prior art wheels, and the abrasion is reduced compared to other wheels available in the market.

Similar advantages are achieved when manufacturing flexible annular segments, sliced from corrugated shaped tank produced via a blow molding process for producing the same as will be described with reference to FIG. 6 below.

FIG. 5 is a schematic isometric view of a corrugated tube 200 with a large number of segments 20, wherein each segment comprises multiple layers made by an extrusion process. Each segment is configured to be cut off the tube and to be assembled on a wheel hub to thereby produce a wheel suitable for use in various products from the type mentioned above.

FIG. 6 is a schematic illustration of one other example for producing flexible segments configured to be assembled with a wheel hub by a blow molding process. In such example, a cross section view of corrugated tank 350 is shown. A mold is used in a blow molding process to produce flexible corrugated tank 350 with a plurality of segments 20′ to be sliced and assembled on a wheel hub in a similar manner as previously described. A pre-defined number of segments are produced according to the mold in use. Molten sleeve of one or more layers is blown under air pressure 150 into the mold. In this specific example, a melt of two layers: an outer layer made of rubber (TPE) 14′, and inner layer made of polypropylene (PP) 13′ are used, to create the corrugated shaped tank. After cooling, the mold is removed and slices are then cut from the corrugated tank according to cutting lines 19 so as to produce desired flexible segments to be assembled on a wheel hub that may further be covered by a cover to provide the final product with an elegant and chic appearance. In should be clear to a person skilled in the art that in such production method a single layer or multiple layers may be blown via the molten sleeve under air pressure into the mold and the above two layers are only an example. In such manufacturing process the annular segments obtained do not contain closed compartments with impounded air as in the extrusion manufacturing process illustrated with reference to FIGS. 4 and 5.

FIG. 7A-7B are schematic isometric view and exploded view illustrations of an example of a wheel 300 in accordance with the present invention. Wheel 300 comprises a flexible annular segment manufactured by a blow molding process. This segment is preferably composed of an outer layer 40 made of a thermoplastic elastomer and an inner layer 42 made of materials such as, but not limited to polypropylene, polyethylene, PVC (Polyvinyl chloride), ABS (Acrylonitrile butadiene styrene), and nylon, Acrylic (poly(methyl methacrylate) (PMMA), and Polybenzimidazole. In a further implementation of the invention additional layers may be added to provide additional strength to the wheel according to specific products requirements, budget abilities and needs.

In order to obtain a functional wheel, the flexible annular segment is assembled with a wheel hub composed of two parts 441 and 442, and configured to support the flexible annular segment from each of its sides and to create a cylinder 18 for insertion of an axle through it, so as to allow connection of the wheel to other components of a product and to additional wheel/s. The two parts of wheel hub 441 and 442 are connected to each other by screws inserted into structural connectors 11. In the example illustrated in these figures, each part of the wheel hub is designed such that no additional cover is needed. In an alternative implementation of the invention, another design of a wheel hub may be used and a decorative cover may further be used for aesthetic purposes. In the isometric view of FIG. 7A only one part of the wheel hub 441 is seen. In a similar manner, at that view only outer layer 40 of the flexible annular segment is shown.

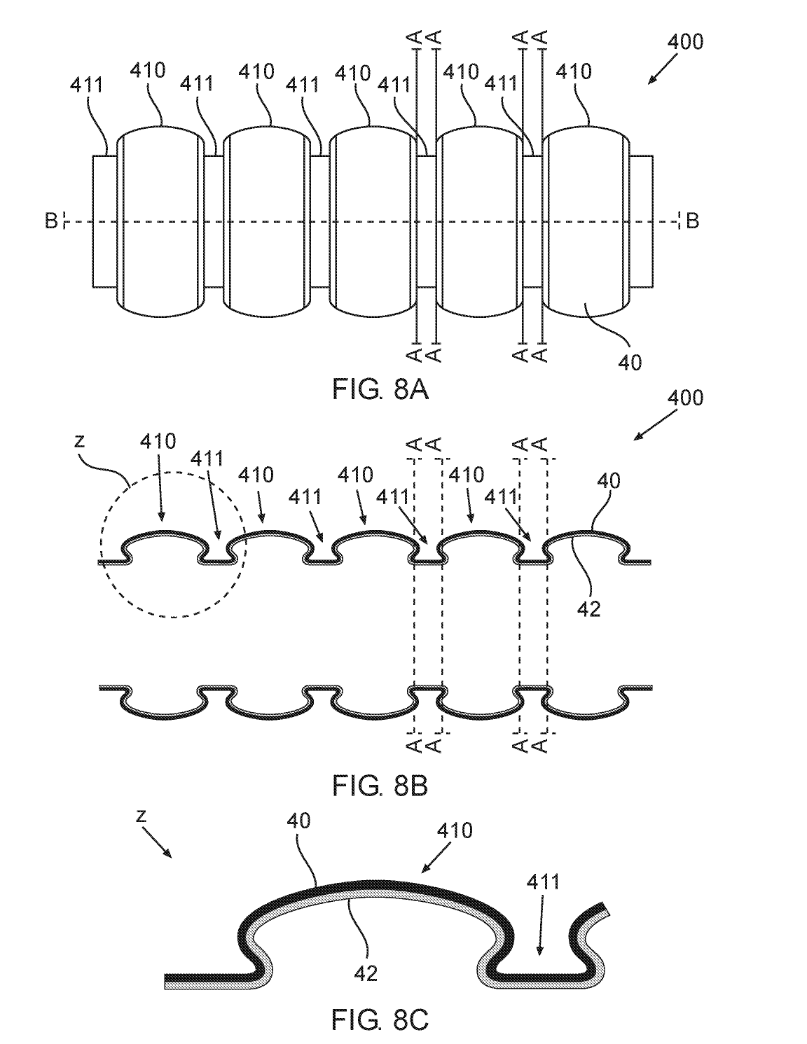

FIG. 8A-8C are schematic illustrations of a blow molded corrugated shaped tank 400 wherein FIG. 8A illustrates a front view of the tank after it is cooled and removed from the mold; FIG. 8B is a cross section view of the blow molded tank of FIG. 8A along line B-B showing the inner structure of the blow molded corrugated tank, and FIG. 8C is a close up view of a part of an annual flexible segment shown in the cross section view of FIG. 8B in area “Z”. Tank 400 is made of a sequence of rounded segments 410 separated one from the other by areas 411. The tank created in the blow molding process is usually a closed tube. For producing the novel wheel of the invention the closed corrugated tank is sliced into the annular segments 410, wherein the cuts are made along the two ends of areas 411 surrounding each segment through lines A. After slicing the segments, areas 411 may be recycled and used as layers for further production of wheels.

The cross section view of blow molded tank 400 further illustrates the corrugated structure of the tank and the layers comprising it. As mentioned in the above, the outer layer 40 that is made of a thermoplastic elastomer configured and operable to provide the wheel with high quality and functional abilities, eliminating the noise that is made by chipping of plastic wheels from usage, and minimizing shock and wear. The inner layer 42 is usually made of cheaper materials, thus, allowing reduction of the cost of the wheel without compromising on the quality or spoiling the exclusive look of the final product. Close up view on area “Z” views a part of a segment that serves as the flexible component of the wheel. In the specific example, segment 410 is shown encompassed on both sides by area 411 that will be cut for separating the functional segment. As can be seen, both the segments 410 and areas 411 are made of the same materials and contain outer layer 40 and inner layer 42. In a further implementation of the invention additional layers made from various materials may be added either between the inner and outer layer as intermediates, or as inner layers.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A wheel comprising:
a. a flexible annular segment manufactured by a blow molding process, said segment having at least one layer made of a thermoplastic elastomer; and
b. a wheel hub configured to support the flexible annular segment from each of its sides and to create a cylinder for insertion of an axle therethrough so as to allow connection of the wheel to other components of a product.

2. A wheel according to claim 1, wherein said thermoplastic elastomer is selected from the group consisting of thermoplastic rubber, EVA (Ethylene Vinyl Acetate), PVC rubber, Styrenic block copolymers (TPE-s),Polyolefm blends (TPE-o), Elastomeric alloys (TPE-v or TPV), Thermoplastic polyurethanes (TPU), Thermoplastic copolyester, and Thermoplastic polyamides.

3. A wheel according to claim 1, wherein said flexible annular segment comprises at least two layers: an outer layer made of a thermoplastic elastomer that is configured to serve as a shock absorber and or as a wear resistant layer; and an inner layer made of at least one of the following materials: polypropylene, polyethylene, PVC (Polyvinyl chloride), ABS (Acrylonitrile butadiene styrene), and nylon.

4. (canceled)

5. (canceled)

6. A wheel according to claim 1, wherein said flexible annular segment is a slice of a corrugated shape tank manufactured in a blow molding process.

7. A wheel according to claim 1, wherein said product is selected from the group consisting of: strollers, children vehicles, carts, trolley bags, luggage trollies, tricycles, scooters and bicycles.

8. A wheel according to claim 1, wherein the cylinder configured to allow insertion of an axle therethrough, allows connection of said wheel to an additional wheel.

9. A wheel according to claim 1, wherein said flexible annular segment is manufactured by an extrusion process.

10. A method for manufacturing a wheel, said method comprising the following steps:
a. Creating a blow molded corrugated shape tank with at least one layer of a thermoplastic elastomer via a blow molding process;
b. Slicing annular segments of said blow molded tank;
c. Assembling said sliced annular segments on a wheel hub for supporting said flexible annular segment from each of its sides and creating a cylinder for insertion of an axle therethrough to allow connection of the wheel to other components of a product.

11. A method for manufacturing a wheel according to claim 10, wherein said blow molded tank comprises a plurality of segments, wherein each segment is structurally separated from adjacent segments, and wherein said segments are flexible segments.

12. (canceled)

13. A method for manufacturing a wheel according to claim 10, wherein said thermoplastic elastomer is selected from the group consisting of thermoplastic rubber, EVA (Ethylene Venyl Acetate), PVC rubber, Styrenic block copolymers (TPE-s), Polyolefin blends (TPE-o), Elastomeric alloys (TPE-v or TPV), Thermoplastic polyurethanes (TPU), Thermoplastic copolyester, and Thermoplastic polyamides.

14. A method for manufacturing a wheel according to claim 10, wherein said annular segments comprise at least two layers: an outer layer made of a thermoplastic elastomer, and an inner layer made of at least one of the following materials: polypropylene, polyethylene, PVC (Polyvinyl chloride), ABS (Acrylonitrile butadiene styrene), and nylon.

15. A method for manufacturing a wheel according to claim 14, wherein said outer layer made of thermoplastic elastomer is configured to serve as a shock absorber and/or as a wear resistant layer.

16. (canceled)

17. A method for manufacturing a wheel according to claim 10, wherein said product is selected from the group consisting of: strollers, children vehicles, carts, trolley bags, luggage trollies, tricycles, scooters and bicycles.

18. A method for manufacturing a wheel according to claim 10, wherein said cylinder configured to allow insertion of an axle therethrough allows connection of said wheel to additional wheel.

19. A method for manufacturing a wheel according to claim 10, wherein said tank is a corrugated tube created by an extrusion molding process.

20. A wheel comprising:
a. a flexible annular segment manufactured by an extrusion molding process, said segment having at least one layer made of a thermoplastic elastomer; and
b. a wheel hub configured to support said flexible annular segment from each of its sides and to create a cylinder for insertion of an axle therethrough so as to allow connection of the wheel to other components of a product.

21. A wheel according to claim 20, wherein said thermoplastic elastomer is selected from the group consisting of thermoplastic rubber, EVA (Ethylene Venil Acetate), PVC rubber, Styrenic block copolymers (TPE-s), Polyolefin blends (TPE-o), Elastomeric alloys (TPE-v or TPV), Thermoplastic polyurethanes (TPU), Thermoplastic copolyester, and Thermoplastic polyamides.

22. A wheel according to claim 20, wherein said flexible annular segment comprises at least two layers: an outer layer made of a thermoplastic elastomer that is configured to serve as a shock absorber and/or as a wear resistant layer, and an inner layer made of at least one of the following materials: polypropylene, polyethylene, PVC (Polyvinyl chloride), ABS (Acrylonitrile butadiene styrene), and nylon.

23. (canceled)

24. A wheel according to claim 20, wherein said flexible annular segment is a slice of a corrugated tube manufactured in an extrusion molding process.

25. A wheel according to claim 20, wherein said product is selected from the group consisting of: strollers, children vehicles, carts, trolley bags, luggage trollies, tricycles, scooters and bicycles.

26. A wheel according to claim 20, wherein said cylinder is configured to allow insertion of an axle therethrough, allows connection of said wheel to an additional wheel.

27. A wheel according to claim 22, further comprising a third layer positioned in parallel to the two other layers in a manner so as to create, together with the two other layers, a closed compartment, providing the wheel with inherent shock absorbing characteristics.
